(19) United States
(12) Patent Application Publication
(10) Pub. No.: US 2016/0107531 A1
(43) Pub. Date: Apr. 21, 2016

(54) SYSTEM FOR RECOVERING ELECTRICAL ENERGY FROM MACHINE

(71) Applicant: Caterpillar Inc., Peoria, IL (US)

(72) Inventors: Xinyu Ge, Peoria, IL (US); Qiang Chen, Dunlap, IL (US); Evan E. Jacobson, Edwards, IL (US)

(73) Assignee: Caterpillar Inc., Peoria, IL (US)

(21) Appl. No.: 14/982,069

(22) Filed: Dec. 29, 2015

(51) Int. Cl. B60L 11/18; H02J 7/00; B64C 39/02

(52) U.S. Cl. CPC B60L 11/1822; B64C 39/024; H02J 7/0052; H02J 7/0063; B60L 11/1814; B64C 2201/042; B64C 2201/06; H02J 7/345

(57) ABSTRACT

A system for recovering electrical energy from a machine working at a worksite is provided. The system includes a first capacitor disposed in the machine and adapted to communicate with a inverter of a hybrid drive system of the machine. The system further includes a drone adapted to carry a second capacitor. The drone is adapted to transfer electrical energy between the second capacitor and an electrical grid present at the worksite. The system further includes a docking system disposed on the machine and includes a controller disposed in communication with the machine and the drone.

### TECHNICAL FIELD

The present disclosure relates to a hybrid drive system in a machine, and more particularly to a system for recovering electrical energy from the machine.

### BACKGROUND

Generally, at a worksite, machines such as a dump truck, articulated truck, loader, excavator, pipe layer, and motor grader, operate with heavy payloads. Further, the machines include a hybrid drive system having an electric motor for driving wheels of the machine. As such, when the machines move in an ascending path, engines of the machines may need to provide sufficient power to operate with heavy payloads. However, when the machines travel in a descending path, the power provided by the engines is lesser than that of the machines moving in the ascending path. Further, when the machines move in the descending path, the wheels may drive the electric motor, which in turn act as a generator and produces electrical energy. The electrical energy can be captured by capacitors or batteries present in the machine. However, the capacitors or the batteries present in the machine may not have sufficient capacity to recover the electrical energy generated during the movement of the machine in the descending path.

U.S. Pat. No. 9,056,676 (the '676 patent) discloses systems and methods for docking an unmanned aerial vehicle (UAV) on another vehicle. The UAV may be able to distinguish a companion vehicle from other vehicles. The UAV may take off and/or land on the companion vehicle and may be controlled by the companion vehicle. The UAV may be in communication with the companion vehicle while in flight. The companion vehicle may charge the UAV when the UAV is not fully charged. However, the UAV of the '676 patent is used to gather information at the worksite but is not used for various other applications.

### SUMMARY OF THE DISCLOSURE

According to an aspect of the present disclosure, a system for recovering electrical energy from a machine working at a worksite is provided. The system includes a first capacitor disposed in the machine. The first capacitor is adapted to store the electrical energy received from an inverter of a hybrid drive system of the machine. The system further includes a drone adapted to carry a second capacitor. The second capacitor is adapted to receive the electrical energy from the inverter of the hybrid drive system of the machine. The drone is further adapted to transfer electrical energy between the second capacitor and an electrical grid present at the worksite. The system further includes a docking system disposed on the machine. The docking system is adapted to support the drone during transfer of the electrical energy from the inverter to the second capacitor. The system further includes a controller disposed in communication with the machine and the drone. The controller is adapted to receive, via a sensing unit, a signal indicative of a movement of the machine along a traveling path. The controller is further adapted to determine the movement of the machine based on the signal received from the sensing unit. The controller is further adapted to communicate with the first capacitor to store the electrical energy received from the inverter, when the movement of the machine is in a descending path. The controller is further adapted to receive an input signal indicative of the electrical energy stored in the first capacitor and the second capacitor. The controller is further adapted to communicate with the drone, when the energy stored in the first capacitor reaches a maximum energy storage limit. The drone is positioned on the docking system for communicating the second capacitor with the inverter of the machine. The controller is further adapted to communicate with the second capacitor to receive any excess electrical energy from the inverter of the hybrid drive system of the machine. The second capacitor is coupled to an electric port defined in the docking system, and the electric port is in electric communication with the inverter of the machine. The controller is further adapted to communicate with the drone to transfer any surplus electrical energy stored in the second capacitor to the machine, when the machine requires an electrical energy more than an electrical energy generated by the inverter of the hybrid drive system during the movement of the machine.

Other features and aspects of this disclosure will be apparent from the following description and the accompanying drawings.

### BRIEF DESCRIPTION OF THE DRAWINGS

FIG. 1 shows a side view of an exemplary machine, according to one embodiment of the present disclosure;

FIG. 2 is a system for recovering electrical energy from the machine; and

FIG. 3 is a flowchart of a method of recovering the electrical energy from the machine.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

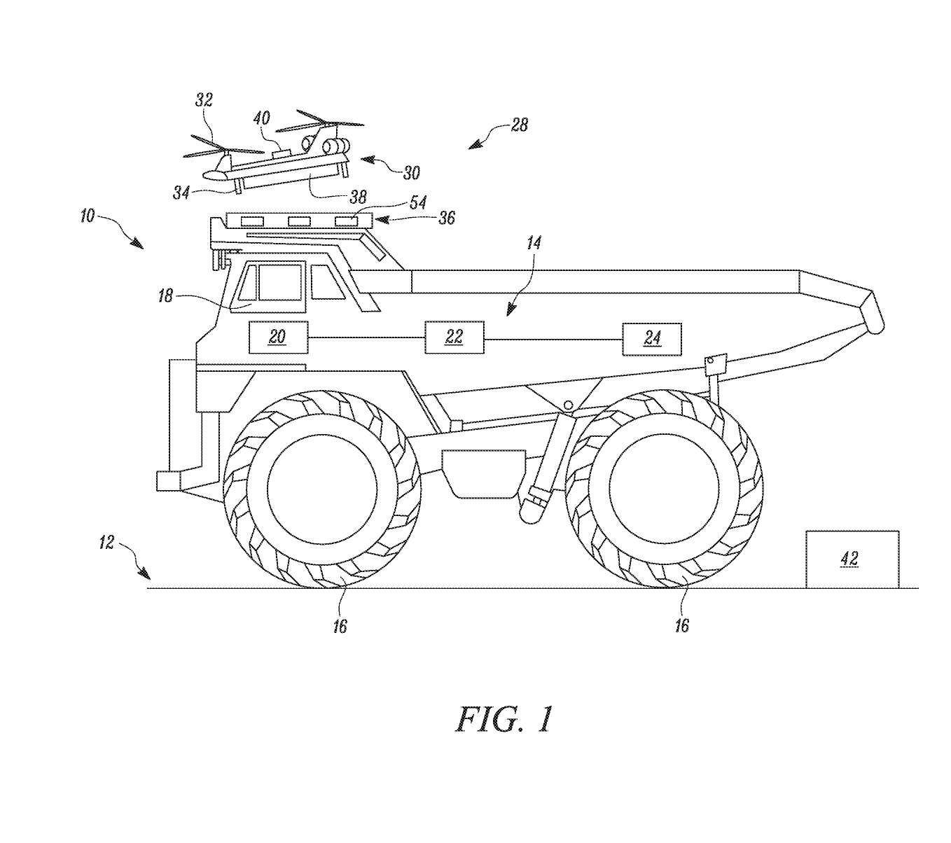

FIG. 1 illustrates a side view of an exemplary machine 10, according to an embodiment of the present disclosure. The machine 10 is embodied as a large mining truck (LMT) operating at a worksite 12. Alternatively, the machine 10 may be an off-highway truck, on-highway truck, dump truck, articulated truck, loader, excavator, pipe layer, and motor grader. The machine 10 may be any machine associated with various industrial applications, including, but not limited to, mining, agriculture, forestry, construction, and other industrial applications. The machine 10 includes a hybrid drive system 14. The machine 10 also includes a plurality of ground-engaging elements 16 for propelling the machine 10. In the illustrated embodiment the ground-engaging elements 16 are wheels.

Further, the machine 10 includes an operator control station 18 to control movement and operation of the machine 10. The hybrid drive system 14 includes an engine 20, a generator 22, and one or more electric motors 24 associated with the ground engaging elements 16. The electrical energy is further supplied to the electric motors 24 for driving the ground engaging elements 16. The hybrid drive system 14 further includes a braking system (not shown) to control a speed of the machine 10 while moving on an ascending path or a descending path.

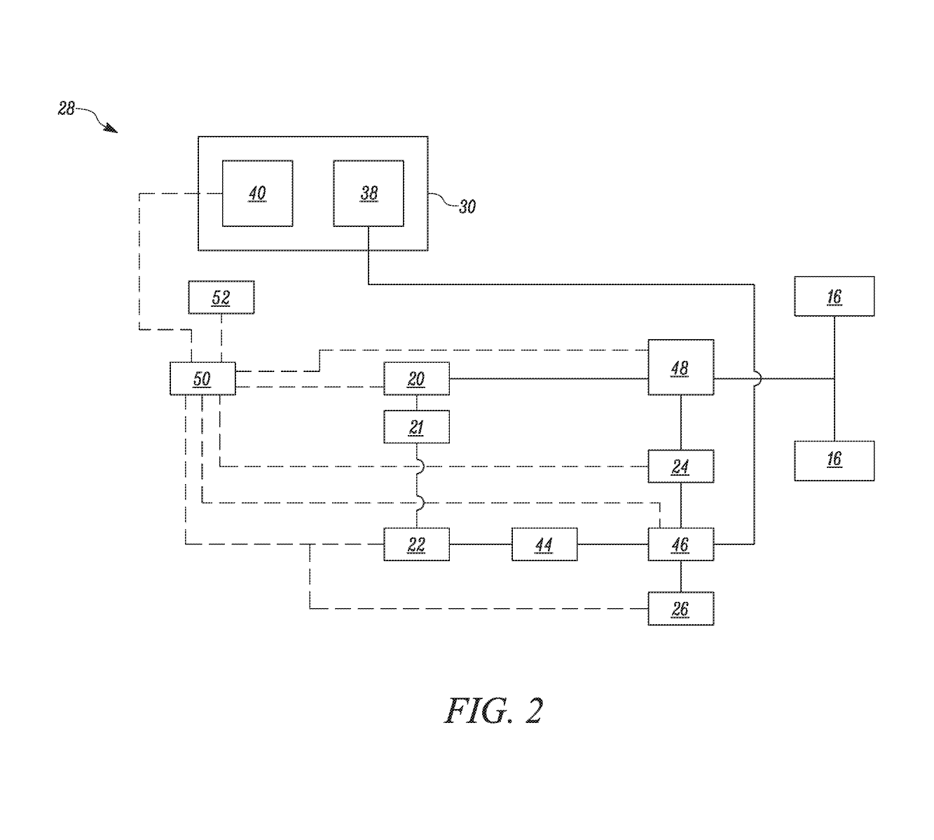

The hybrid drive system 14 further includes a first capacitor 26 (as shown in FIG. 2) disposed in the machine 10. The first capacitor 26 is adapted to store the electrical energy received from the inverter 46 (as shown in FIG. 2) of the hybrid drive system 14. In an example, the first capacitor 26 may be an onboard energy recovery and storage system. The first capacitor 26 communicates with the inverter 46 to receive and store the electrical energy received from the inverter 46.

Referring to FIGS. 1 and 2, a system 28 for recovering electrical energy from the machine 10 is illustrated in detail. The system 28 includes a drone 30 to capture and transfer excess electrical energy generated by the hybrid drive system 14. In an example, the drone 30 is an unmanned aerial vehicle including one or more propellers 32 and a landing support 34. The system 28 further includes a docking system 36 disposed on the machine 10. The docking system 36 is used as a landing facility for the drone 30 to land on the docking system 36 using the landing support 34. The drone 30 further includes a second capacitor 38 and a drone controller 40 such that the docking system 36 provides an interface to transfer the electrical energy from the hybrid drive system 14 of the machine 10 to the second capacitor 38. The second capacitor 38 is adapted to receive the electrical energy from the inverter 46 of the hybrid drive system 14. In an example, the docking system 36 is located on top of the machine 10. Alternatively the docking system 36 can be located anywhere on the machine 10.

The drone 30 may be further configured to transfer the electrical energy stored in the second capacitor 38 to an electric grid system 42 provided at the worksite 12. In an example, the electric grid system 42 may include solar panels, gensets, energy storage devices, and any other device for receiving electrical energy from the drone 30.

The hybrid drive system 14 of the machine 10 is illustrated in detail in FIG. 2. The hybrid drive system 14 shown in FIG. 2 is a power split hybrid powertrain system which includes the engine 20 and the generator 22. In an example, the generator 22 is driven by a turbine 21, which in turn, is driven by the engine 20. The exhaust gases from the engine 20 impinges on blades of the turbine 21, thereby driving the turbine 21 at a speed. Further, the turbine 21 is operatively coupled to the generator 22, via a shaft (not shown). During operation, the engine 20 generates rotational power to drive the generator 22 to produce electrical power, for example, in the form of an alternating current (AC). The alternating current is supplied to a rectifier 44 and is converted to direct current (DC). The direct current may be further converted to alternating current by an inverter 46. The inverter 46 is capable of selectively adjusting frequency and/or pulse-width of its output, such that the electric motor 24 that is connected to the output of the inverter 46 is operated at variable speeds and torques. The electric motor 24 is connected via a final drive assembly 48 to the ground-engaging elements 16 of the machine 10. The final drive assembly 48 may include a continuous variable transmission (CVT) and a transfer gear box. Additionally, the final drive assembly 48 is coupled to the engine 20. When the machine 10 is moving in the descending path, the ground engaging elements 16 rotate the electric motors 24, which then act as electric generators. The electrical energy is generated by the electric motors 24. Further, the inverter 46 receives the electrical energy generated by the electric motors 24.

The system 28 further includes a controller 50 configured to communicate with the hybrid drive system 14 of the machine 10 and the drone 30. Further, the controller 50 communicates with the engine 20, the generator 22, the inverter 46, and the final assembly 48, the electric motor 24, and the first capacitor 26. The controller 50 is in communication with a sensing unit 52 to receive a signal indicative of a movement of the machine 10 in a traveling path. In an example, the traveling path may be the ascending path or the descending path at the worksite 12. The controller 50 further determines the movement of the machine 10 based on the signal received from the sensing unit 52. In an example, the sensing unit 52 may include, but is not limited to, a grade sensor and/or a speed sensor to determine the movement of the machine 10. The controller 50 communicates with the first capacitor 26 to store the excess electrical energy received from the inverter 46.

Further, the controller 50 receives an input signal indicative of the electrical energy stored in the first capacitor 26. The controller 50 also communicates with the drone controller 40 of the drone 30 to dock the drone 30 on the docking system 36 when the energy stored in the first capacitor 26 reaches a maximum energy storage limit. In an example, the controller 50 may wirelessly communicate with the drone controller 40 of the drone 30. In yet another example, the controller 50 may communicate with the drone controller 40 of the drone 30 via global positioning system (GPS).

Upon receipt of signals from the controller 50, the drone 30 is landed on the docking system 36. Subsequently, the controller 50 communicates with the inverter 46 of the machine 10 to direct the electrical energy to the second capacitor 38, instead of the first capacitor 26. Alternatively, based on signals from the controller 50, the drone 30 may pick up the second capacitor 38 located on the machine 10 to transfer the electrical energy to the electrical grid system 42 present at the worksite 12. Alternatively, the second capacitor 38 may also be located on top of the machine 10. The drone 30 transfers electrical energy between the second capacitor 38 and the electrical grid system 42 present at the worksite 12. The drone 30 is positioned on the docking system 36 to aid in electric communication between the second capacitor 38 with the inverter 46 of the machine 10.

The inverter 46 of the machine 10 transfers excess electrical energy to the second capacitor 38 via an electric port 54. The electric port 54 is in electric communication with the inverter 46 of the machine 10. Further, the controller 50 communicates with the drone 30 to transfer any additional electrical energy stored in the second capacitor 38 to the machine 10, when the machine 10 requires electrical energy more than the electrical energy generated by the inverter 46 during the movement of the machine 10. In an example, a storage device, such as a flywheel (not shown), may be used to store rotational energy which may be converted into electrical energy.

### INDUSTRIAL APPLICABILITY

The present disclosure relates to the hybrid drive system 14 for recovering electrical energy from the machine 10 working at the worksite 12. In an example, the electrical energy recovered from the machine 10 may be used for another machine, when the movement of that machine 10 is in the ascending path. Also, the electrical energy recovered from the machine 10 may be used by the machine 10, when the movement of the machine 10 is in the ascending path. The drone 30 captures the electrical energy from the machine 10 during its movement in the descending path. The second capacitor 38 present in the drone 30 stores and supplies electrical energy to other machines working in the working site 12.

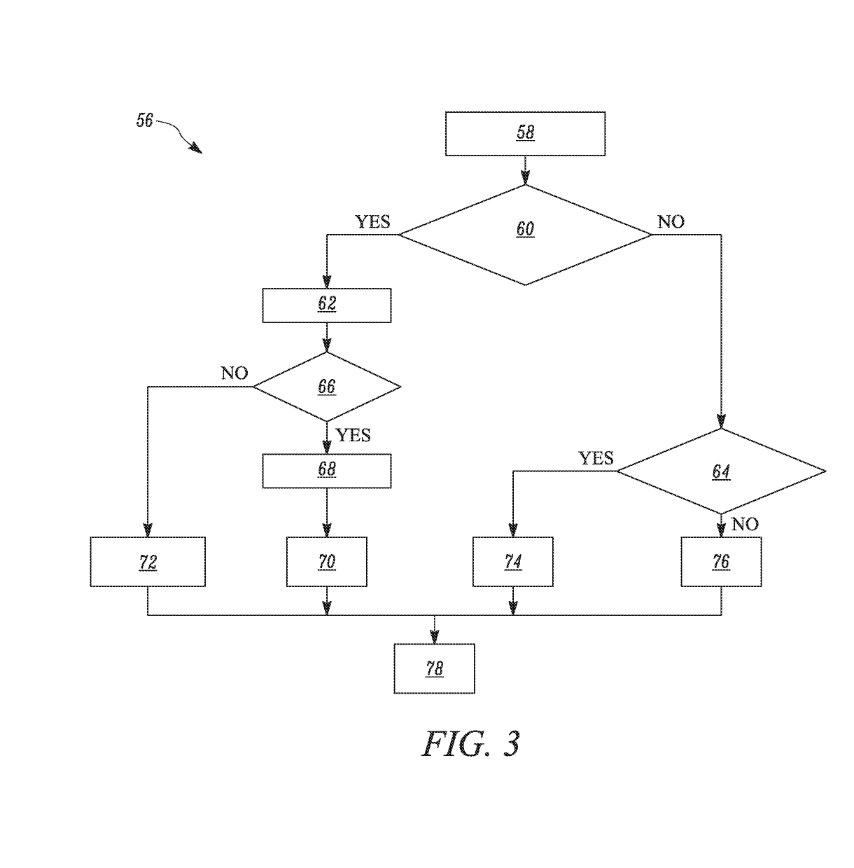

FIG. 3 is a flowchart for a process 56 of recovering electrical energy, according to an embodiment of the present disclosure. In an embodiment, FIG. 3 illustrates the process 56 that may be implemented by the controller 50 in order to take a decision on transferring electrical energy from the first capacitor 26 present in the machine 10 to the second capacitor 38 present in the drone 30. In an example, the controller 50 may be remotely located. The process 56 of taking the decision of transferring energy starts at block 58. After the process 58 of taking the decision of transferring energy has started at block 58, the process 56 moves to block 60. At block 60, the controller 50 determines whether the machine 10 is moving on the descending path in response to signals received from the grade sensors present in the machine 10. If the controller 50 determines that the machine 10 is moving on the descending path, the process 56 moves to block 62.

At block 62, the inverter 46 receives the electrical energy from the electric motors 24. Also, at block 62, the first capacitor 26 in the machine 10 is charged. Alternatively, if the controller 50 determines that the machine 10 is moving in a path other than the descending path, the process 56 moves to block 64. At block 64, the controller 50 determines whether the machine 10 requires excess energy input for movement of the machine 10 at the worksite 12. Further, after the inverter 46 receives the electrical energy at block 62, the process 56 moves to block 66. At block 66, the controller 50 determines whether first capacitor 26 present in the machine 10 has reached a maximum energy storage limit. If the first capacitor 26 present in the machine 10 has reached a maximum energy storage limit, the process 56 moves to block 68.

Further, at block 68, the controller 50 communicates signals to the drone controller 40 requesting the drone 30 with the second capacitor 38. In an example, the second capacitor 38 requested might have zero energy stored. When the controller 50 receives a signal requesting the drone 30, the process 56 moves to block 70. At block 70, the second capacitor 38 in the drone 30 is charged continuously. Referring again to block 66, if the first capacitor 26 present in the machine 10 has not reached a maximum energy storage limit, the process 56 moves to block 72. At block 72, the first capacitor 26 present in the machine 10 is charged continuously. Referring again to block 64, if the controller 50 determines that the machine 10 requires excess energy input, the process 56 moves to block 74. At block 74, the controller 50 receives signals requesting transfer of the electrical energy from the drone 30. Alternatively, if the controller 50 determines that the machine 10 does not require excess energy input, the process 56 moves to block 76. At block 76, the controller 50 deactivates the energy transfer function to the machine 10 from the drone 30. The process 56 ends at block 78.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for recovering electrical energy from a machine working at a worksite, the system comprising:
a first capacitor disposed in the machine, the first capacitor adapted to store electrical energy received from an inverter of an hybrid drive system of the machine;
a drone adapted to carry a second capacitor, the second capacitor adapted to receive the electrical energy from the inverter of the hybrid drive system, wherein the drone is adapted to transfer electrical energy between the second capacitor and an electrical grid present at the worksite;
a docking system disposed on the machine, the docking system adapted to support the drone during transfer of the electrical energy from the inverter to the second capacitor; and
a controller disposed in communication with the machine and the drone, the controller adapted to:
receive, via a sensing unit, a signal indicative of a movement of the machine along a traveling path;
determine the movement of the machine based on the signal received from the sensing unit;
communicate with the first capacitor to store the electrical energy received from the inverter, when the movement of the machine is in a descending path;
receive an input signal indicative of the electrical energy stored in the first capacitor and the second capacitor;
communicate with the drone, wherein the drone is positioned on the docking system for communicating the second capacitor with the inverter of the machine;
communicate with the second capacitor to receive any excess electrical energy from the inverter of the hybrid drive system of the machine, wherein the second capacitor is coupled to an electric port defined in the docking system, and the electric port is in electric communication with the inverter of the machine; and
communicate with the drone to transfer any surplus electrical energy stored in the second capacitor to the machine, when the machine requires an electrical energy more than the electrical energy generated by the inverter of the hybrid drive system during the movement of the machine.
